(19) United States
(12) Patent Application Publication
(10) Pub. No.: US 2006/0213078 A1
(43) Pub. Date: Sep. 28, 2006

(54) Gas delivery system with moving knife

(76) Inventor: Daniel J. VanderPyl, Yorba Linda, CA (US)

Correspondence Address: SHELDON & MAK, INC, 225 SOUTH LAKE AVENUE, 9TH FLOOR, PASADENA, CA, 91101, US

(21) Appl. No.: 11/098,191

(22) Filed: Mar. 24, 2005

(51) Int. Cl. F26B 3/00; F26B 9/00; F26B 13/00; F26B 13/06

(52) U.S. Cl. 34/487; 34/638; 34/634

(57) ABSTRACT

A system (18) for treating a work piece (12) with pressurized gas (16) from a gas source (14) includes a holder (49) for holding the work piece (12), a knife (52A) that is in fluid communication with the gas source (14), and a support (54A) that allows for movement of the knife (52A). The knife (52A) includes an outlet (64) for discharging the pressurized gas (16) towards the work piece (12) and impinging upon the work piece (12). The support (54A) allows the knife (52A) to move laterally relative to the work piece (12) while the knife (52A) is directing the pressurized gas (16) toward the work piece (12) with the work piece (12) being maintained substantially stationary.

### BACKGROUND

There is great difficulty in rapidly and efficiently drying parts in the plating industry. In one type of plating process, a plurality of parts is secured to a plating rack that is approximately 10 foot long and 5 foot high. One system for drying the parts on the plating rack includes a 10 foot long air knife positioned on each side of the rack to blow air onto the parts, and a hoist mechanism that moves the rack up and down past the air knife. Unfortunately, the hoist mechanism is typically used in other procedures of the plating process and is only available for a limited time for the drying process. In certain designs, the limited time available for the hoist mechanism to dry the rack of parts allows only 2-4 passes of the rack past the air knife. Unfortunately, many parts are not completely dried in 2-4 passes.

Moreover, the air turbulence created during movement of the rack of parts past the air knives can cause damage to the parts. In order to avoid part damage, the air velocity from the air knives is lowered. This further reduces the drying rate. As a result thereof, existing systems are not entirely capable of rapidly and efficiently drying parts in the plating industry.

### SUMMARY

The present invention is directed to a system for treating a target surface of a work piece with pressurized gas from a gas source such as for drying the target surface. The gas delivery system includes a holder, a gas knife that is in fluid communication with the gas source, and a support. The holder holds the work piece in a substantially stationary position. The gas knife includes an outlet that discharges the pressurized gas towards the target surface for impinging upon the target surface. In one embodiment, the support allows the knife to move laterally across the target surface while the knife is directing the pressurized gas toward the target surface. With this design, in certain embodiments, the system can rapidly and efficiently dry the target surface without moving the work piece with a hoist mechanism.

The target surface has a first dimension measured along a first axis and a second dimension measured along a second axis that is perpendicular to the first axis. In certain designs, the knife discharges the pressurized gas towards the target surface along substantially the entire first dimension and the holder holds the work piece so that the target surface is substantially vertical.

In one embodiment, the support allows the knife to move substantially parallel to the target surface and the support allows the knife to move a sufficient distance that so that substantially the entire target surface is contacted with the gas. As an example, the support can allow the knife to move relative to the target surface along substantially the entire second dimension.

In another embodiment, the support provides the knife with fluid communication with the gas source. For example, the support can include a first outlet and a spaced apart second outlet. With this design, pressurized gas flows from the first outlet to the knife when the knife is in a first position near the first outlet. Similarly, pressurized gas flows from the second outlet to the knife when the knife is in a second position near the second outlet.

Additionally, the system can include a seal assembly that inhibits the flow of the pressurized gas from the second outlet to the surrounding environment when the knife is in the first position. Similarly, the seal assembly can inhibit the flow of the pressurized gas from the first outlet to the surrounding environment when the knife is in the second position. In one version, the seal assembly includes a flexible hose that encircles a portion of the support.

The present invention is also directed to a system that includes a second knife that is fluid communication with the gas source and a second support. The second knife has an outlet for discharging the pressurized gas towards a second target surface of the work piece. The second support allows the second knife to move laterally relative to the work piece while the second knife is directing the pressurized gas toward the work piece. With this design, in certain embodiments, the system can rapidly dry both sides of a work piece.

Moreover, the present invention is directed to a method for preparing a target surface of a work piece. The method includes the steps of holding the work piece, discharging pressurized gas from a knife towards the target surface, and moving the knife laterally relative to the target surface while the knife is directing the gas toward the target surface.

### BRIEF DESCRIPTION OF THE DRAWINGS

FIG. 1A is a simplified perspective illustration of a system having features of the present invention and a work piece to be treated by the system;

FIG. 1B is a simplified perspective illustration of another embodiment of a system according to the present invention, and a work piece to be treated by the system;

FIG. 2A is a perspective view of a knife having features of the present invention;

FIG. 2B is a perspective view of another embodiment of a knife having features of the present invention;

FIG. 3A is a perspective view of a portion of a manifold assembly and a yoke having features of the present invention;

FIG. 3B is a partly exploded perspective view of the components shown in FIG. 3A;

FIG. 4A is a side plan view of the yoke of FIG. 3A;

FIG. 4B is an exploded perspective view of the yoke of FIG. 3A;

FIG. 4C is a cut-away taken on line 4C-4C in FIG. 4A;

FIG. 5A is a simplified cut-away view of a portion of the manifold assembly and the yoke of FIG. 3A, with the yoke in a first position; and

FIG. 5B is a simplified cut-away view of a portion of the manifold assembly and the yoke of FIG. 3A, with the yoke in a second position.

### DESCRIPTION

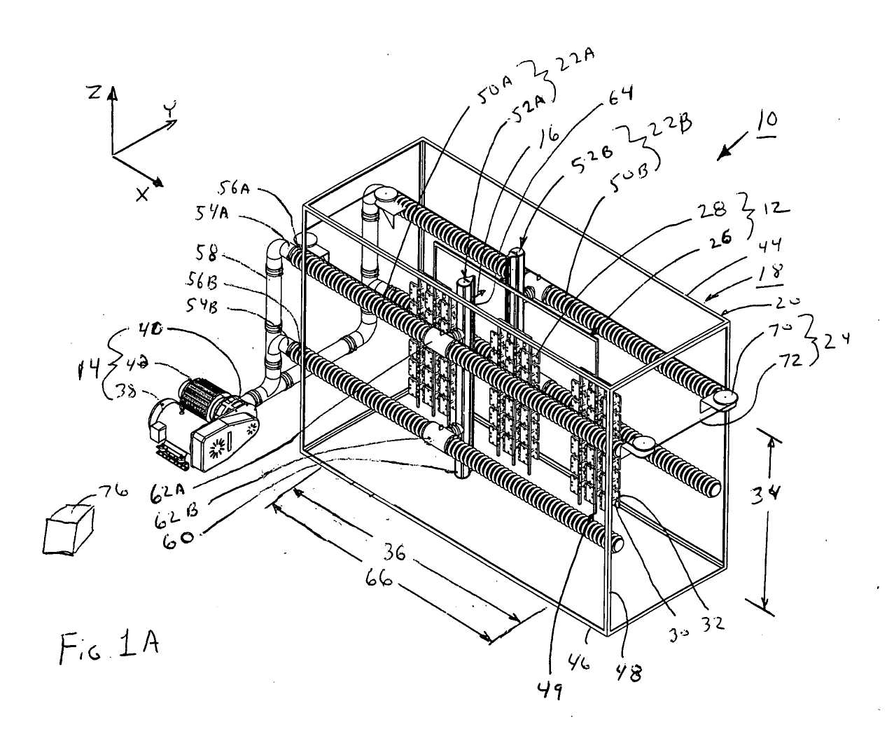

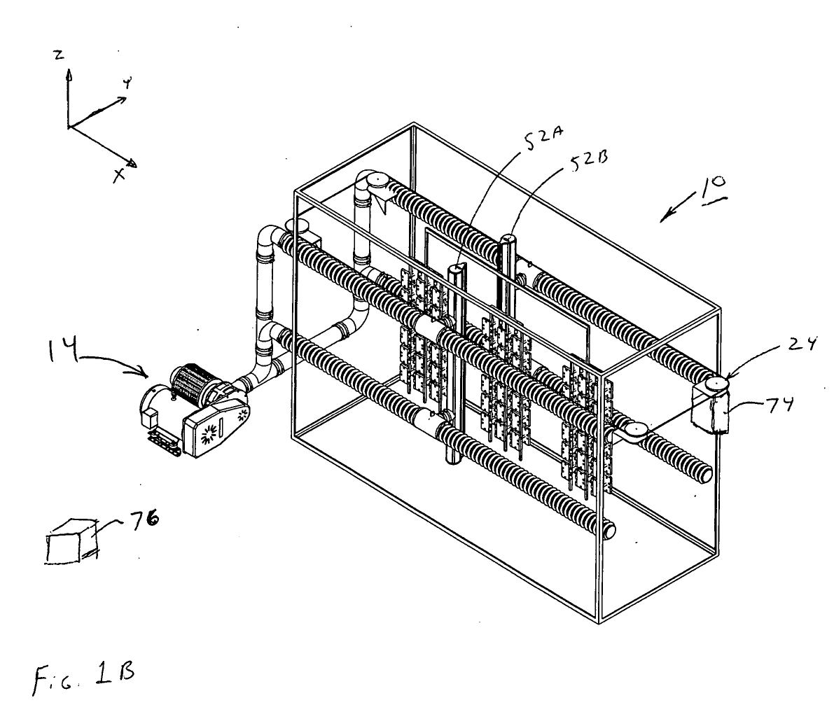

FIG. 1A is simplified perspective illustration of a work piece treatment system 10, also referred to as a preparation device, having features of the present invention, and a work piece 12 to be treated by drying. The system 10 includes a source 14 of pressurized gas 16 (illustrated as an arrow) and a gas delivery system 18 that discharges the pressurized gas 16 at the work piece 12. In one embodiment, the delivery system 18 includes an apparatus frame 20, a first delivery device 22A, a second delivery device 22B, and a movement assembly 24. Alternatively, for example, the delivery system 18 can be designed with more than two or less than two delivery devices 22A, 22B. The size, shape, design and organization of these components can be varied pursuant to the teachings provided herein to suit the design requirements of the preparation device 10 and the work piece 12.

A number of Figures include an orientation system that illustrates an X axis, a Y axis that is perpendicular to the X axis, and a Z axis that is perpendicular to the X and Y axes. It should be noted that these axes can also be referred to as the first, second and third axes.

In certain embodiments, the treatment system 10 rapidly and efficiently prepares the work piece 12 while the work piece 12 is maintained in a substantially stationary position. The type of treatment performed on the work piece 12 can be tailored to meet the type of process needed to be performed on the work piece 12. For example, the treatment system 10 can be used for blowing off moisture and debris, drying, static neutralizing, coating control, cooling and/or heating one or more target surfaces of the work piece 12. In one embodiment, the treatment system 10 is used for quickly drying parts during a plating process or a painting process.

The type, size and shape of the work piece 12 that is prepared by the preparation device 10 can be varied. In FIG. 1A, the work piece 12 has a preparation rack 26 and a plurality of parts 28 that are retained on the preparation rack 26 such as by clips (not shown). In this embodiment, the work piece 12 includes a first target surface 30 and an opposed second target surface 32. Further, the work piece 12 has a first dimension 34 and a second dimension 36. In FIG. 1A, the work piece 12 is retained with the target sides 30, 32 maintained in a vertical orientation, and the first dimension 34 is measured vertically along the Z axis, and the second dimension 36 is measured horizontally along the X axis. Alternatively, for example, the orientation of the work piece 12 and the gas delivery system 18 can be rotated.

Additionally, in FIG. 1A, the second dimension 36 is greater than the first dimension 34. As a non-exclusive example, a typical rack of parts for plating has a first dimension 34 of approximately 5 feet and a second dimension 36 of approximately 10 feet. Alternatively, for example, the second dimension 36 can be approximately equal to the first dimension 34 or the first dimension 34 can be greater than the second dimension 36.

The gas source 14 provides pressurized gas 16 to the delivery system 18. The type of pressurized gas 16 utilized and the flow rate and pressure of the gas 16 can be varied to suit the requirements for treating the work piece 12 and the design of the gas delivery system 18. As a non-exclusive example, the gas 16 can be air that is delivered to the delivery system 18 at a flow rate of between about 10 and about 2000 cubic feet per minute, and at a pressure of between about 0.5 and 10 psig. Alternatively, for example, the gas 16 can be another type of gas, such as nitrogen, oxygen, carbon dioxide or helium, and the flow rate and pressure can be greater or lesser than the amounts detailed above.

In FIG. 1A, the gas source 14 includes a motor 38, a pump 40, and a filter 42. The motor 38 is mechanically coupled to and rotates the pump 40. The filter 42 filters the gas 16. Alternatively, for example, the gas source 14 can include multiple motors 38, pumps 40, filters 42, fans, blowers and/or compressors. Still alternatively, the gas source 14 could include a heater assembly (not shown) that heats the gas 16, a chiller assembly (not shown) that chills the gas 16, and/or a gas regulator (not shown) that regulates gas flow.

The apparatus frame 20 supports the other components of the gas delivery system 18. In FIG. 1A, the apparatus frame 20 is generally rectangular frame shaped and includes (i) an upper frame 44 that is formed by four rigid beams that are arranged in a rectangular pattern, (ii) a lower frame 46 that is formed by four rigid beams that are arranged in a rectangular pattern and a bottom plate, and (iii) four, spaced apart, rigid side beams 48 that secure the upper frame 44 to the lower frame 46. The apparatus frame 20 can be made of a rigid material such as steel, aluminum or suitable material. The apparatus frame 20 can be mounted to a mounting base, the ground, floor, or some other supporting structure.

In one embodiment, a holder 49 retains the work piece 12 and maintains the work piece 12 in a substantially stationary, vertical position during the preparation of the work piece 12. Subsequently, a hoist (not shown) can be used to move the work piece 12 after preparation is completed. It should be noted that with this design, the hoist can be used in other manufacturing procedures during the preparation of the work piece 12 with the treatment system 10. In FIG. 1A, the holder 49 is secured to the apparatus frame 20. In this embodiment, the holder 49 receives a portion of the preparation rack 26. A variety of techniques can be used for the holder 49 to hold the rack 26, such as providing each end of the rack 26 with support rods (not shown) and provide the frame 20 with V-blocks (not shown) to cradle the rods.

The parts 28 can be held stably against the force of the pressurized gas on the rack 26 by use of clips, by having opposed gas stream impinging on the parts 28, and/or by lowering the velocity of the gas streams (while raising gas temperature to achieve fast drying).

The first delivery device 22A directs the gas 16 at the first target surface 30 of the work piece 12 and the second delivery device 22B directs the gas 16 at the second target surface 32 of the work piece 12.

In FIG. 1A, the first delivery device 22A includes a first manifold assembly 50A and a first knife 52A. In one embodiment, the first manifold assembly 50A transfers the pressurized gas 16 from the gas source 14 to the first knife 52A, connects the first knife 52A to the apparatus frame 20, allows the first knife 52A to move laterally across the work piece 12 while the first knife 52A is directing the pressurized gas 16 toward the work piece 12, and guides the movement of the first knife 52A relative to the apparatus frame 20 and the work piece 12.

In this embodiment, the first manifold assembly 50A includes an upper support 54A, an upper seal assembly 56A, a lower support 54B that is spaced apart from the upper support 54A, a lower seal assembly 56B, and a manifold connector conduit 58. Alternatively, for example, the first manifold assembly 50A can be designed with more than two or less than two supports 54A, 54B and seal assemblies.56A, 56B.

In FIG. 1A, each support 54A, 54B is fixedly secured to the apparatus frame 20 and the manifold connector conduit 58 connects each support 54A, 54B in fluid communication with the gas source 14. In this embodiment, each support 54A, 54B guides the movement of the first gas knife 52A and connects the first gas knife 52A in fluid communication with the gas source 14. Alternatively, for example, a separate device, e.g. a linear bearing, can be used for guiding the movement of the first knife 52A, and a separate conduit can be used for connecting the first knife 52A in fluid communication with the gas source 14. In certain embodiments, the first knife 52A can be moved relative to the work piece 12 without having hoses and the like hanging in the way of the work piece 12.

The first knife 52A includes a conduit 60, an upper yoke 62A, and a lower yoke 62B. Alternatively, for example, the first knife 52A can be designed to have more than two or less than two yokes 62A, 62B. The gas conduit 60 includes an outlet 64 that directs and discharges the gas 16 towards the first target surface 30 of the work piece 12 for impinging upon the first target surface 30.

In the embodiment illustrated in FIG. 1A, the second delivery device 22B includes a second manifold assembly 50B and a second knife 52B that are similar in design to the corresponding component of the first delivery device 22A. Alternatively, the second delivery device 22B can be somewhat different in design to the first delivery device 22A.

In one embodiment, the first knife 52A and the second knife 52B each move a movement distance 66 laterally relative to the work piece 12 and the apparatus frame 20. In FIG. 1A, each knife 52A, 52B moves horizontally along the X axis, substantially parallel to the work piece 12, and the movement distance 66 is approximately equal to or greater than the second dimension 36 of the work piece 12. As a result thereof, each knife 52A, 52B can be moved a sufficient distance so that substantially each entire target surface 30, 32 can be contacted with the gas 16. With this design, in certain embodiments, by moving the gas knives 52A, 52B across the target surfaces 30, 32 of the work piece 12, one knife 52A, 52B per target surface 30, 32 can prepare the work piece 12 without moving the work piece 12 and without use of the hoist.

Alternatively, for example, the gas delivery system 18 can be designed so that one or both of the knives 52A, 52B moves vertically back and forth along the Z axis or moves a movement distance 66 that is less than the second dimension 36. In non-exclusive embodiments, the movement distance 66 is at least approximately 50, 60, 70, 80, or 90 percent of the second dimension 36. The knives 52A, 52B can be moved concurrently or independently.

In one embodiment, each knife 52A, 52B is oriented to extend along the shorter of the dimensions 34, 36 of the work piece 12. With this design, each knife 52A, 52B is usually only required to be as long as the shorter of the dimensions 34, 36. This reduces the gas volumes versus a longer knife required to cover the longer of the dimensions 34, 36. In FIG. 1A, each knife 52A, 52B extends vertically along the Z axis parallel with the first dimension 34. Alternatively, one or both of the knives 52A, 52B can be oriented to extend along the longest of the dimensions 34, 36.

The movement assembly 24 facilitates the movement of the knives 52A, 52B relative to the work piece 12 and the apparatus frame 20. In one embodiment, the movement assembly 24 facilitates the concurrent movement of the knives 52A, 52B in opposite directions in a reciprocating fashion back and forth along the work piece 12. In FIG. 1A, the movement assembly 24 includes (i) four spaced apart pulleys 70 that are fixedly secured to the apparatus frame 20 via the manifold assemblies 50A, 50B and (ii) a cable 72 that extends around the pulleys 70. The cable 72 is also secured to the knives 52A, 52B. With this design, (i) rotation of the pulleys 70 in the clockwise rotational direction causes the first knife 52A to move from right to left along the X axis and the second knife 52B to move from left to right along the X axis, and (ii) rotation of the pulleys 70 in the counterclockwise rotational direction causes the first knife 52A to move from left to right along the X axis and the second knife 52B to move from right to left along the X axis. Alternatively, the movement assembly 24 can be designed to move the knives 52A, 52B independently at the same rate or at different rates.

In FIG. 1A, the movement assembly 24 facilitates movement of the knives 52A, 52B manually. Alternatively, referring to FIG. 1B, the movement assembly 24 can include a mechanism 74 that moves the knives 52A, 52B. The mechanism 74 can be means that includes one or more pneumatic, hydraulic or electric motors. Further, sprockets, rack and pinion and/or pistons can be used to in the movement assembly 24.

Referring to FIGS. 1A and 1B, the preparation device 10 can include a control system 76 that controls one or more the electrical components of the preparation device 10. In FIG. 1A, the control system 76 controls the operation of the gas source 14 and in FIG. 1B, the control system 76 controls the operation of the gas source 14 and the mechanical means 74.

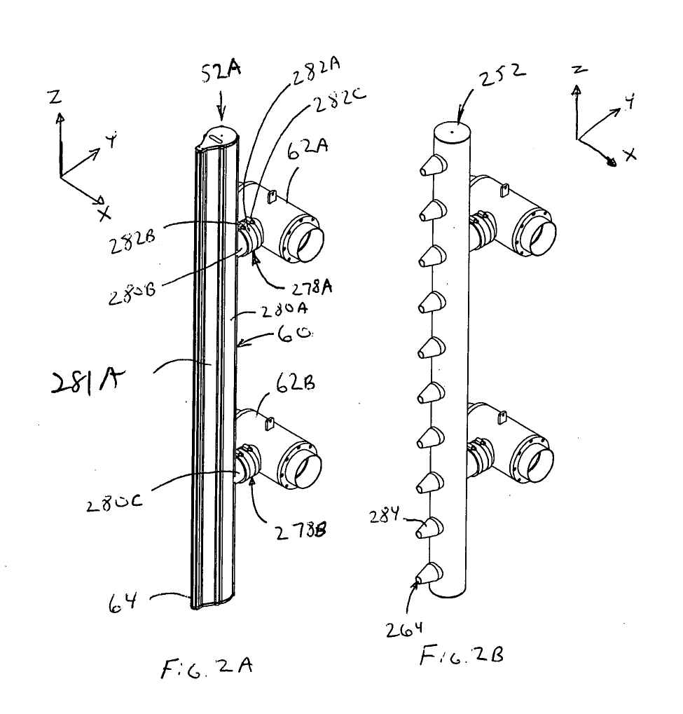

FIG. 2A is a perspective view of the first knife 52A including the conduit 60, the upper yoke 62A, the lower yoke 62B, an upper yoke connector 278A, and a lower yoke connector 278B. The size and shape of the conduit 60 can be varied to suit the preparation requirements of the work piece 12 (illustrated in FIG. 1A). In FIG. 2A, the conduit 60 includes (i) a generally tubular shaped main region 280A that includes a curved area and a somewhat “V” shaped area 281A (which optionally can be rounded), (ii) the outlet 64, (iii) a tubular shaped upper conduit inlet 280B, and (iii) a tubular shaped lower conduit inlet 280C.

The design of the outlet 64 can vary. In FIG. 2A, the outlet 64 is defined by a generally rectangular shaped, long and narrow aperture in the edge of the main region 280A. With this design, the outlet 64 simultaneously releases the pressurized gas 16 (illustrated in FIG. 1A) along the Z axis and along at least a portion of the first dimension 34 (illustrated in FIG. 1A). In alternative, non-exclusive embodiments, the outlet 64 simultaneously directs the pressurized gas 16 along at least approximately 60, 70, 80, 90 or 100 percent of the first dimension 34.

The upper yoke connector 278A connects the upper conduit inlet 280B to the upper yoke 62A and the lower yoke connector 278B connects the lower conduit inlet 280C to the lower yoke 62B. In FIG. 2A, each yoke connector 278A, 278B includes an annular shaped tube 282A, a first fastener 282B that secures the tube 282A to the respective conduit inlet 280B, 280C and a second fastener 282C that secures the tube 282A to the respective yoke 62A, 62B. Each fastener 282B, 282C, for example, can be a hose clamp, an adhesive, or another type of fastener.

FIG. 2B is a perspective view of another embodiment of a knife 252 that can be used as the first knife 52A and/or the second knife 52B in the delivery system 18 of FIG. 1A. The knife 252 is somewhat similar to the first knife 52A illustrated in FIG. 2A. However, in this embodiment, the outlet 264 includes a plurality of nozzles 284 that are spaced along the Z axis.

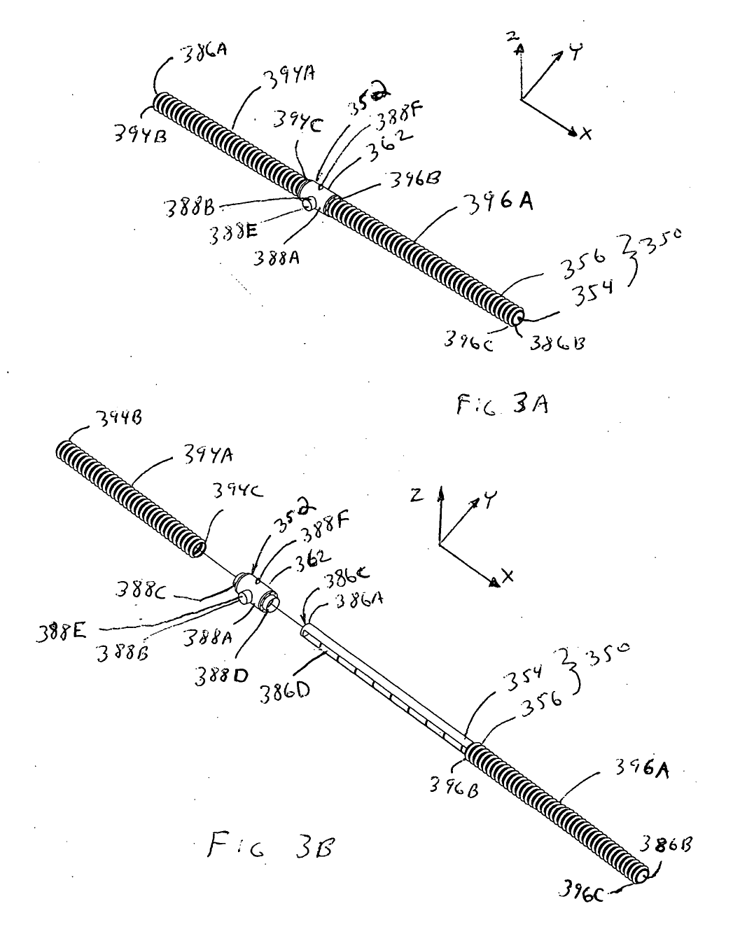

FIG. 3A is a perspective view and FIG. 3B is a partly exploded perspective view of (i) a portion of a manifold assembly 350, namely a support 354 and a seal assembly 356, and (ii) a yoke 362 of a knife 352, that can be used as part of the first delivery device 22A (illustrated in FIG. 1A) or the second delivery device 22B (illustrated in FIG. 1A). In this embodiment, the yoke 362 is designed to move along substantially the entire length of the support 354. Alternatively, the system can be designed so that the yoke 362 moves along only a portion of the length of the support 354.

The support 354 transfers the pressurized gas 16 (illustrated in FIG. 1A) from the gas source 14 (illustrated in FIG. 1A) to the knife 352, and guides the movement of the yoke 362. In FIGS. 3A and 3B, the support 354 is generally rigid and generally tubular and includes a proximal support end 386A, an opposed distal support end 386B, a support inlet 386C and a plurality of spaced apart support outlets 386D. In this embodiment, the support 354 has a generally circular tube shape with cutouts. Alternatively, for example, the support 354 could have another shape, such as a rectangular tube shape or an oval tube shape, as non-exclusive examples. The support 354 can be made of a rigid material such as steel, aluminum or suitable material.

The support inlet 386C is in fluid communication with the gas source 14 so that pressurized gas 16 from the gas source 14 is directed into the support 354. The size, shape, location and number of support inlet(s) 386C can be varied to achieve the flow requirements for the support 354. In FIG. 3B, the support inlet 386C is located at the proximal support end 386A and the distal support end 386B is enclosed. Alternatively, for example, the support conduit 354 can include a support inlet 386C on each end 386A, 386B or another location.

The support outlets 386D release the pressurized gas 16 from the support 354. The size, shape, location and number of support outlets 386D can be varied. In the embodiment illustrated in FIG. 3B, the support outlets 386D are spaced apart along the X axis along one side of the support 354 and are positioned along substantially the entire length of the travel of the yoke 362. In non-exclusive, alternative embodiments, the support outlets 386D are spaced apart to maximize gas velocity to the target surfaces 30 and 32.

Further, in this embodiment, each support outlet 386D is a generally rectangular shaped opening in the support 354 and has a support outlet area. In non-exclusive, alternative embodiments, the support outlet area is equal to or greater than the open area of the internal passageway 388F. Alternatively, each support outlet 386D can have a different shape or the support outlets 386D can be positioned along only a portion of the support 354.

The yoke 362 moves back and forth along the support 354 and receives the pressurized gas 16 from the support 354. In the embodiment illustrated in FIGS. 3A and 3B, the yoke 362 is shaped somewhat similar to a pipe tee and includes a tubular shaped follower section 388A and a tubular shaped connector section 388B that extends transversely to the follower section 388A. In this embodiment, the follower section 388A encircles a portion of the support 354, and has a size and shape that corresponds to the shape of the support 354. In this embodiment, the follower section 388A is generally circular tube shaped and includes a proximal yoke end 388C and a distal yoke end 388D.

The connector section 388B defines an internal yoke passageway 388E. In one embodiment, the yoke passageway 388E is substantially tangential to a central axis of the support 354. The yoke passageway 388E can have a passageway cross sectional area is that approximately equal to or greater than the support outlet area to reduce fluid friction losses. Further, the yoke passageway 388E can have a cross-sectional shape that somewhat corresponds to the shape of each support outlet 386D.

Additionally, the yoke 362 can include an attachment flange 388F that extends upward from the follower section 388A. In one embodiment, the movement assembly 24 (illustrated in FIG. 1A) is secured to the flange 388F of the yoke 362. With this design, the movement assembly 24 can move the yoke 362 and the knife 352.

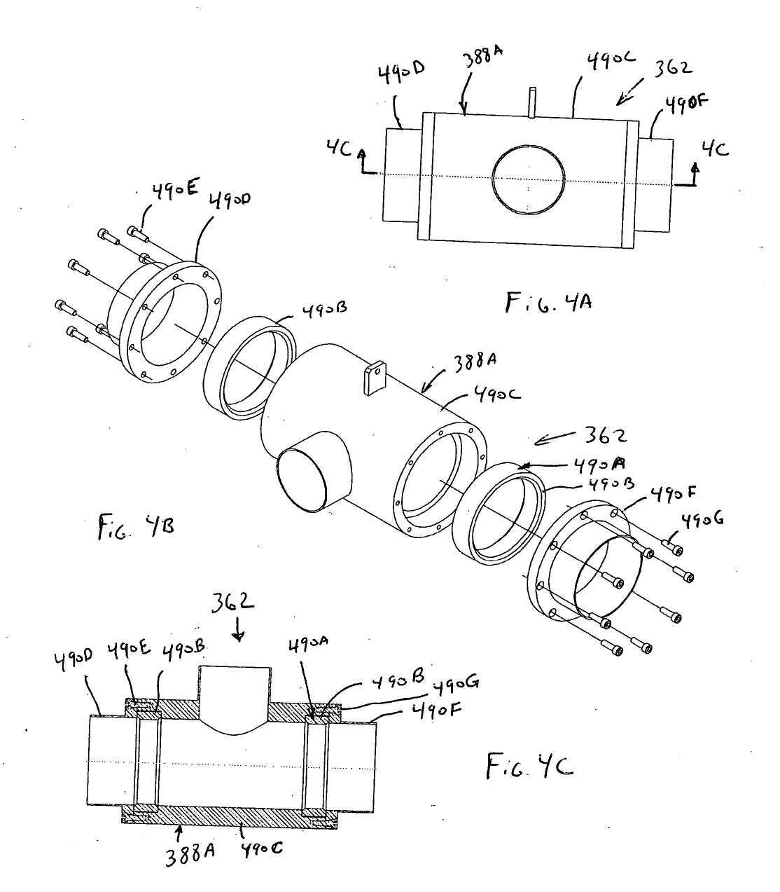

FIG. 4A illustrates a side view, FIG. 4B is an exploded perspective view and FIG. 4C is a cut-away view of the yoke 362. In one embodiment, the yoke 362 includes a guide 490A that provides a relatively low friction surface that contacts the support 354 (illustrated in FIGS. 3A and 3B) and facilitates easy movement of the yoke 362 relative to the support 354 without wear to either surface. As an example, the guide 490A can include a pair of spaced apart bushings 490B that are secured to the follower section 388A and that engage the support 354. In FIGS. 4A-4C, the follower section 388A includes (i) a main part 490C, (ii) a proximal flange 490D, (iii) a proximal fastener assembly 490E, e.g. a plurality of bolts, that secure the proximal flange 490D to the main part 490C with one bushing 490B retained thereby, (iv) a distal flange 490F, and (v) a distal fastener assembly 490G e.g. a plurality of bolts, that secure the distal flange 490F to the main part 490C with one bushing 490B retained thereby.

Referring back to FIGS. 3A and 3B, the seal assembly 356 seals the support outlets 386D that are not aligned with the yoke 362 and inhibits the pressurized gas that exits these support outlets 386D from being released to the surrounding environment. Stated another way, the seal assembly 356 is mounted over the support 356 so that pressurized gas does not go out of the support outlets 386D, except for the one or more support outlets 386D that are aligned with the yoke 362 of the knife 352. Further, in certain embodiments, the seal assembly 356 allows the yoke 362 to move relative to the support 354 with minimal resistance.

In one embodiment, the seal assembly 356 includes (i) a first seal 394A that encircles a portion of the support 354 and that is positioned on the proximal side of the yoke 362, and (ii) a second seal 396A that encircles a portion of the support 354 and that is positioned on the distal side of the yoke 362. Further, the first seal 394A includes a proximal seal end 394B that is secured to the proximal support end 386A and a distal seal end 394C that is secured to the proximal yoke end 388C. Somewhat similarly, the second seal 396A includes a proximal seal end 396B that is secured to the distal yoke end 388D and a distal seal end 396C that is secured to the distal support end 386B. Each end of each seal 394A, 396B can be secured with a clamp, or another type of fastener.

With this design, movement of the yoke 362 along the support 354 causes the distal seal end 394C of the first seal 394A and the proximal seal end 396B of the second seal 396A to move concurrently with the yoke 362. In one embodiment, the each seal 394A, 396B is flexible hose that includes a plurality of pleats. Further, each hose has a length that is approximately equal in length to the entire support 354. As the knife 352 and the yoke 362 move along the length of the support 354, each seal 394A, 396B collapses or extends as needed to accommodate the position of the yoke 362 along the length of the support 354.

In certain embodiments, the present design allows for reciprocating movement of the knife 352 across the length of the support 354 while having very low fluid friction losses, and having no flex hoses or other appendages which intrude on the work space area.

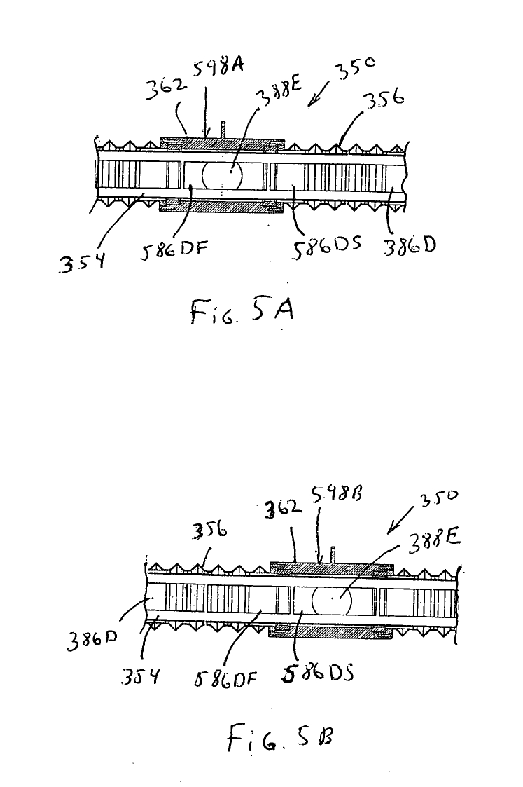

FIG. 5A is a simplified cut-away view of a portion of the manifold assembly 350 and the yoke 362 in a first position 598A. In this position, the yoke 362 is positioned near a first support outlet 586DF of the support 354 and pressurized gas from within the support 354 flows from the first support outlet 586DF to the internal passageway 388E of the yoke 362. Further, in the first position 598A, the seal assembly 356 inhibits the flow of the pressurized gas from a second support outlet 586DS and the other support outlets 386D to the surrounding environment.

FIG. 5B is a simplified cut-away view of a portion of the manifold assembly 350 and the yoke 362 in a second position 598B. In this position, the yoke 362 is positioned near the second support outlet 586DS of the support 354 and pressurized gas from within the support 354 flows from the second support outlet 586DS to the internal passageway 388E of the yoke 362. Further, in the second position 598B, the seal assembly 356 inhibits the flow of the pressurized gas from the first support outlet 586DF and the other support outlets 386D to the surrounding environment.

Moreover, although the invention has been described with regard to use with a gas (which includes gas/liquid mixtures), and principally air, it is possible certain features of the invention are useful with fluids in general. The term “fluid” refers to gases, liquids, emulsions, gas flow entraining particulates, sols, gels and the like.

Also, the term “pressurized” refers to the pressure of the gas relative to the pressure at the target. Thus, if the target is in a vacuum, the pressure of the pressurized gas can be less than atmospheric pressure.

Also, the term “gas source” is not limited to a single gas source but can include multiple gas sources, i.e., each knife can have its own gas source.

While the particular invention as shown and disclosed herein is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for treating a work piece having a target surface with pressurized gas from a gas source, the system comprising:
(a) a holder for holding the work piece;
(b) a gas knife for placement in fluid communication with the gas source, the knife including an outlet for discharging pressurized gas towards the target surface for impinging upon the target surface; and
(c) a support for the knife configured to allow the knife to move laterally across the target surface while the knife is directing the pressurized gas toward the target surface with the target surface being maintained substantially stationary by the holder.

2. The system of claim 1 wherein the support is configured to allow the knife to move substantially parallel to the target surface.

3. The system of claim 1 wherein the holder holds the work piece so that that target surface is substantially vertical during movement of the knife laterally across the target surface.

4. The system of claim 1 wherein the support is configured to allow the knife to move a sufficient distance so that substantially the entire target surface can be contacted with the pressurized gas.

5. The system of claim 1 wherein the target surface has a first dimension along a first axis and the knife discharges the pressurized gas towards the target surface along substantially the entire first dimension.

6. The system of claim 5 wherein the target surface has a second dimension along a second axis that is perpendicular to the first axis, and the support allows the knife to move relative to the target surface along substantially the entire second dimension.

7. The system of claim 1 further comprising a movement assembly for moving the knife relative to the work piece.

8. The system of claim 1 wherein the support connects the knife in fluid communication with the gas source, the support including an inlet that is in fluid communication with the gas source.

9. The system of claim 8 wherein the support includes a first outlet and a spaced apart second outlet, wherein pressurized gas flows from the first outlet to the knife when the knife is in a first position and pressurized gas flows from the second outlet to the knife when the knife is in a second position.

10. The system of claim 9 further comprising a seal assembly that inhibits the flow of the pressurized gas from the second outlet to the surrounding environment when the knife is in the first position, and that inhibits the flow of the pressurized gas from the first outlet to the surrounding environment when the knife is in the second position.

11. The system of claim 10 wherein the seal assembly includes a flexible hose that encircles a portion of the support.

12. A work piece treatment system including the system of claim 1 and a source of pressurized gas.

13. A system for preparing a work piece with pressurized gas from a gas source, the system comprising:
(a) a holder for holding the work piece, the work piece having a first target surface and a second target surface;
(b) a first knife for placement in fluid communication with the gas source, the first knife including a first outlet for discharging the pressurized gas towards the first target surface for impinging upon the first target surface;
(c) a first support supporting the first knife and configured to allow the first knife to move laterally relative to the first target surface while the first knife is directing the pressurized gas toward the first target surface with the first target surface being maintained substantially stationary by the holder;
(d) a second knife for placement in fluid communication with the gas source, the second knife including a second gas outlet for discharging the pressurized gas towards the second target surface for impinging upon the second target surface; and
(e) a second support supporting the second knife and configured to allow the second knife to move laterally relative to the second target surface while the second knife is directing the pressurized gas toward the second target surface with the second target surface being maintained substantially stationary by the holder.

14. The system of claim 13 wherein the first support allows the first knife to move substantially parallel to the first target surface and the second support allows the second knife to move substantially parallel to the second target surface.

15. The system of claim 13 further comprising a movement assembly that moves the knives relative to the work piece.

16. The system of claim 13 wherein the first support connects the first knife in fluid communication with the gas source, the second support connects the second knife in fluid communication with the gas source.

17. A system for preparing a work piece with pressurized gas from a gas source, the system comprising:
(a) means for holding the work piece having a target surface;
(b) an outlet means being placed in fluid communication with the gas source, the outlet means discharging the pressurized gas towards the target surface for impinging upon the target surface; and
(c) means for moving the outlet means laterally relative to the target surface while the outlet means is directing the pressurized gas toward the target surface with the target surface being maintained substantially stationary.

18. The system of claim 17 wherein the means for moving allows the knife to move substantially parallel to the target surface.

19. The system of claim 17 wherein the means for moving connects the outlet means in fluid communication with the gas source.

20. A method for treating a target surface of a work piece, the method comprising the steps of:
(a) holding the work piece;
(b) discharging pressurized gas from a knife towards the target surface for impinging upon the target surface; and
(c) moving the knife laterally relative to the target surface while the knife is directing the pressurized gas toward the target surface with the target surface being maintained substantially stationary.

21. The method of claim 20 wherein the step of moving includes moving the knife substantially parallel to the target surface a sufficient distance so that substantially the entire target surface can be contacted with the pressurized gas.

22. A system for treating a work piece with pressurized gas from a gas source, the system comprising:
(a) a holder for holding the work piece having a target surface;
(b) a knife including an outlet for discharging the pressurized gas towards the target surface for impinging upon the target surface; and
(c) a manifold assembly that allows the knife to move across the target surface between a first position and a second position, the manifold assembly being in fluid communication with the gas source, the manifold assembly including a first outlet and a spaced apart second outlet, wherein pressurized gas flows from the first outlet to the knife when the knife is in the first position and pressurized gas flows from the second outlet to the knife when the knife is in the second position.

23. The system of claim 22 wherein the manifold assembly includes a seal assembly that inhibits the flow of the pressurized gas from the second outlet to the surrounding environment when the knife is in the first position and that inhibits the flow of the pressurized gas from the first outlet to the surrounding environment when the knife is in the second position.

24. The system of claim 22 wherein the manifold assembly allows the knife to move laterally across the target surface while the knife is directing the pressurized gas toward the target surface.
